(19) United States
(12) Patent Application Publication
(10) Pub. No.: US 2023/0086838 A1
(43) Pub. Date: Mar. 23, 2023

(54) VIRTUAL LIVESTOCK MANAGEMENT

(71) Applicant: Corral Technologies, LLC, Atkinson, NE (US)

(72) Inventor: Jack Ryan Jirovec KEATING, Lincoln, NE (US)

(73) Assignee: Corral Technologies, LLC, Atkinson, NE (US)

(21) Appl. No.: 17/946,167

(22) Filed: Sep. 16, 2022

Related U.S. Application Data
(60) Provisional application No. 63/245,558, filed on Sep. 17, 2021.

(51) Int. Cl. A01K 15/02; A01K 11/00; A01K 29/00; G05B 15/02

(52) U.S. Cl. CPC A01K 15/023; A01K 11/008; A01K 29/005; G05B 15/02

(57) ABSTRACT

A system for virtual management of livestock includes a server computer, a primary collar, and a plurality of secondary collars. The server computer receives virtual boundary data, as a user input, which establishes a virtual boundary. The primary collar is worn by and associated with a primary livestock animal and communicates with the server computer via a remote wireless gateway. The plurality of secondary collars communicate wirelessly with one another and with the primary collar via an ad hoc wireless mesh network. Each of the secondary collars is worn by and associated with an individual secondary livestock animal of a plurality of secondary livestock animals. The primary collar receives the virtual boundary data from the server computer, transmits it to the plurality of secondary collars via the wireless mesh network, and provides directional stimulation to the primary livestock animal to encourage it to refrain from crossing the virtual boundary.

### REFERENCE TO RELATED APPLICATIONS

This application claims priority to and benefit of co-pending U.S. Provisional Patent Application No. 63/245,558 filed on Sep. 17, 2021 entitled “Corral Tech” by Jack Keating., having Attorney Docket No. “CORRAL P1000PR”, and assigned to the assignee of the present application, the disclosure of which is hereby incorporated herein by reference in its entirety.

### BACKGROUND

Fences have long been used as a means of containment for groups of animals. Various types of fences are well known in the art, including traditional fences, electric fences, and underground electric fences. While these types of fences are able to successfully confine animals, these means of containment require significant manpower to assemble, move, and take down. Further, in the event that animals need to be moved to a new location, this must be done manually.

More recently, ear tags and collars have been used to monitor and confine animals to specific boundaries. These devices are often fitted with a means of providing stimuli (e.g., a shock, noise, or vibration) when an animal moves outside of the defined boundary. The intensity and location of the stimulus on the animal is important for preventing injury and directing the animal inside the boundary. Also, this confinement method requires the use of user-provided and emplaced stationary base stations for communication between the user device and the collars and/or ear tags, meaning a user likely will have to move the base stations if animals are to be moved to a new location. Further, each device communicates directly with the user device which may result in a large amount of network traffic as well as a short battery life for all of the devices.

### BRIEF DESCRIPTION OF THE DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers, wherein:

FIG. 1 shows an example block diagram of some aspects of a system for virtual livestock management along with a communication infrastructure of the system, with both depicted in conjunction with some example livestock under virtual management within an incremental virtual boundary for confinement, in accordance with one or more embodiments;

FIG. 2A illustrates example short-range wireless communication between a user device and a primary collar, in accordance with one or more embodiments;

FIG. 2B illustrates example short-range wireless communication between a user device and a secondary collar, in accordance with one or more embodiments;

FIG. 3 illustrates an example external diagram of a secondary collar, in accordance with one or more embodiments;

FIG. 4 illustrates a block diagram depicting an example hardware architecture of the secondary collar, in accordance with one or more embodiments;

FIG. 5 illustrates an example external diagram of a primary collar, in accordance with one or more embodiments;

FIG. 6 illustrates a block diagram depicting an example hardware architecture of the primary collar, in accordance with one or more embodiments;

FIG. 7 illustrates a flow diagram depicting an example method for a primary collar to confine a primary livestock animal and/or a group of animals by communicating with a user device and secondary collars, in accordance with one or more embodiments;

FIG. 8 illustrates a flow diagram depicting an example method for a secondary collar to confine a secondary livestock animal by communicating with a primary collar, in accordance with one or more embodiments;

FIG. 9 illustrates a flow diagram depicting an example method in which a primary collar communicates with one or more secondary collars, in accordance with one or more embodiments;

FIG. 10 illustrates a flow diagram depicting an example method of moving a collection of livestock animals, in accordance with one or more embodiments;

FIG. 11 illustrates a flow diagram depicting an example method in which a three-level incremental boundary confines one or more livestock animals, in accordance with one or more embodiments; and

FIGS. 12A-12C illustrate a flow diagram of an example method of virtual livestock management, in accordance with one or more embodiments.

### DETAILED DESCRIPTION

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to be illustrative rather than limiting and thus to cover alternatives, modifications and equivalents, which may be included within the spirit and scope the various embodiments as defined by the appended claims. Furthermore, in this Description of Embodiments, numerous specific details are set forth to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Overview of Discussion

Livestock animals are animals kept, bred, or raised for use (food, income, work) or pleasure, and typically refer to agricultural/farm animals such as cattle, horses, pigs, sheep, goats, and the like. Conventionally, livestock animals are kept confined to pastures or other locations through the use of physical fencing. Although much of the present disclosure is described in the context of the agricultural industries with reference to “livestock,” this is not to be regarded as a limitation of the present disclosure, unless noted otherwise herein. In this regard, it is contemplated herein that embodiments of the present disclosure may be applied to alternative and/or additional animal industries such as dog management and the like.

Conventional systems and methods for moving, tracking, and confining livestock require significant manpower. For example, conventional systems may require for fencing equipment to be installed on or under the ground, which can be time consuming and expensive. Further, current systems require that equipment used for confining (e.g., fences, base stations, and the like) be moved and reinstalled when the user wants to move a group of livestock. Additionally, conventional systems may require the use of a significant number of workers to monitor livestock such as, cattle to make sure they stay in the fencing, and to make sure the cattle are healthy, well-watered, and well-grazed. Taken together, these shortfalls result in significant time and cost when trying to dynamically manage, confine, track, and move livestock.

It is desirable to have devices for confinement that are mobile, able to communicate quickly, and able to provide effective stimuli; and such devices are provided in the system described herein. In order to use collars and/or ear tags as a means of confining and moving animals, a user should be able to define and change boundaries along with being able to train animals to stay within those boundaries; such capabilities are described as part of the system discussed herein. It is desirable to have a method of defining and changing boundaries that is flexible and able to account for fences, gates, land; and such capabilities are described as functions of the system discussed herein.

Embodiments described herein are directed to a system and methods for virtual livestock management to include moving, tracking, monitoring activities of, and virtually confining livestock. It is contemplated herein that the described system and methods may allow for the moving, tracking, monitoring activities of, and confining of livestock to be performed in a more efficient manner by: requiring less/no fencing equipment to be installed as compared to conventional methods/practices which may require substantial fencing; requiring less/no human oversight (in-person with the livestock) as compared to conventional methods which use fence and require a person to check in physically/visually on the livestock being managed; allowing livestock to be moved without needing to move fencing equipment as compared to conventional practices which utilize fencing; allowing livestock to be moved without needing to move user emplaced base stations/communication equipment as compared to conventional practices which movement of user emplaced base stations/communication equipment; and/or allowing livestock to be moved to a directed location without the physical presence of a human or herding dog to assist with the directed moving as compared to conventional practices which require human intervention for directed livestock movements.

Discussion begins with a description of notation and nomenclature. Discussion then shifts to description of a system and some techniques for management and virtual confinement of livestock. Primary and secondary collars for use on livestock animals are described along with various example hardware components and functions thereof. Various example methods are described for training animals to use the primary and secondary collars, for communicating information to and among primary and secondary collars, and for using the primary and secondary collars to move and/or confine livestock animals. Techniques for collecting data on livestock are described, techniques for culling a herd of livestock animals based on collected data are described, and techniques for humanely separating a livestock animal (along with a paired livestock animal or animals) are described. Finally, operation of the system, to include the primary and secondary collars is discussed in conjunction with description of an example method of virtual management of livestock.

### Notation and Nomenclature

Some portions of the detailed descriptions which follow are presented in terms of procedures, logic blocks, processes, modules and other symbolic representations of operations on data bits within a computer memory. These descriptions and representations are the means used by those skilled in the data processing arts to most effectively convey the substance of their work to others skilled in the art. In the present application, a procedure, logic block, process, module, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device/component.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “transmitting,” “receiving,” “providing,” “determining,” “classifying,” “classifying animal activity,” “packaging,” “determining,” “communicating,” “communicatively coupling,” “wirelessly coupling,” “wirelessly communicating,” “providing directional stimulation,” “stimulating,” “directionally stimulating,” “applying directional stimulation,” “receiving animal position data,” “packaging animal position data and animal activity data,” “recording geographic positions,” “collecting head and body positions,” and “collecting,” or the like, refer to the actions and processes of an electronic device or component such as (and not limited to): a processor, a controller, a memory, a sensor (e.g., a temperature sensor, a magnetometer, an accelerometer, a Global Navigation Satellite System receiver, an atmospheric pressure sensor, a heart rate sensor, etc.), a primary collar for a livestock animal, a secondary collar for a livestock animal, a computer, a server computer, or the like. The electronic device/component manipulates and transforms data represented as physical (electronic and/or magnetic) quantities within the registers and/or memories into other data similarly represented as physical quantities within memories and/or registers or other such information storage, transmission, processing, and/or display components.

Embodiments described herein may be discussed in the general context of processor-executable instructions residing on some form of non-transitory processor-readable medium, such as program modules or logic, executed by one or more computers, processors, or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example electronic device(s) described herein may include components other than those shown, including well-known components.

The techniques described herein may be implemented in hardware, or a combination of hardware with firmware and/or software, unless specifically described as being implemented in a specific manner. Any features described as modules or components may also be implemented together in an integrated logic device or separately as discrete but interoperable logic devices. If implemented in software, the techniques may be realized at least in part by a non-transitory computer/processor-readable storage medium comprising computer/processor-readable instructions that, when executed, cause a processor and/or other components of a computer, computer system, or electronic device to perform one or more of the methods and/or actions of a method described herein. The non-transitory computer/processor-readable storage medium may form part of a computer program product, which may include packaging materials.

The non-transitory processor-readable storage medium (also referred to as a non-transitory computer-readable storage medium) may comprise random access memory (RAM) such as synchronous dynamic random access memory (SDRAM), read only memory (ROM), non-volatile random access memory (NVRAM), electrically erasable programmable read-only memory (EEPROM), flash memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such an in-device processor(s) or core(s) thereof, a remotely accessed processor, a digital signal processors (DSPs), general purpose microprocessors, application specific integrated circuits (ASICs), application specific instruction set processors (ASIPs), field programmable gate arrays (FPGAs), microcontrollers, or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a plurality of microprocessors, one or more microprocessors in conjunction with an ASIC or DSP, or any other such configuration or suitable combination of processors.

### Example System

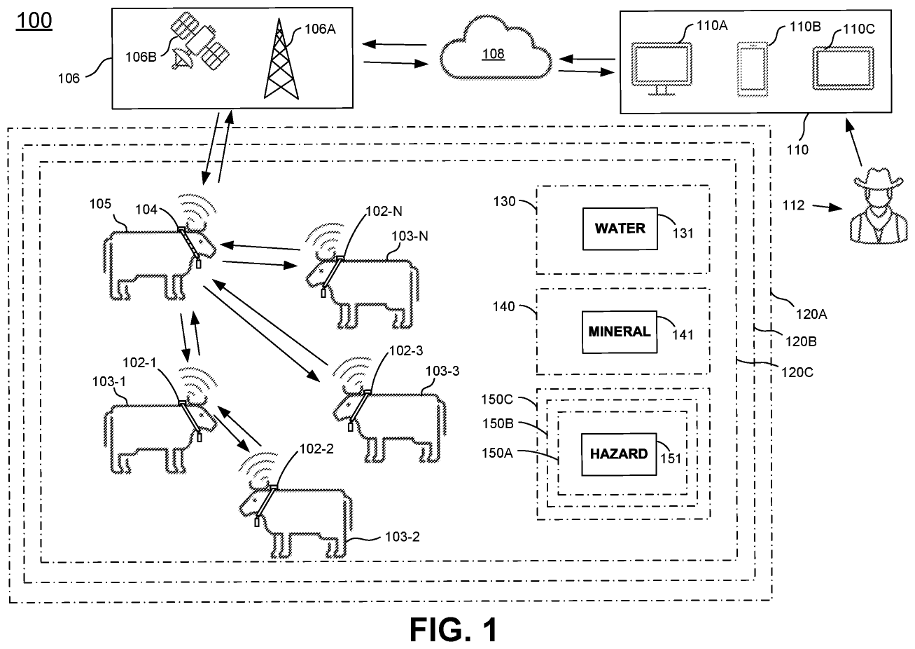

FIG. 1 shows an example block diagram of some aspects of a system 100 for virtual livestock management along with a communication infrastructure of the system 100, with both depicted in conjunction with some example livestock (103, 105) under virtual management within an incremental virtual boundary (120A, 120B, 120C) for confinement, in accordance with one or more embodiments. In some embodiments boundary 120A represents an outer boundary of a grazing area for a plurality of livestock animals.

In embodiments, the system includes a primary collar 104, one or more secondary collars 102, a remote server 108 (which may be internet/cloud-based), and one or more user devices 110. One or more human users may use the device(s) 110 to input data and/or receiving information. Each secondary collar 102 is configured to be worn about the neck of and associated with a single livestock animal, of a plurality of livestock animals, which are designated as the secondary livestock animals 103. The primary collar 104 is configured to be worn about the neck of and associated with a livestock animal which is designated as the primary livestock animal 105. In some embodiments, the primary livestock animal 105 is picked randomly while in others the primary livestock animal 105 may be a leader/alpha-animal of a herd. The primary collar 104 may be communicatively coupled to one or more secondary collars 102 via an ad hoc wireless network/short-range wireless network and to a remote data gateway 106 (e.g., satellites 106B, Wi-Fi base stations (not depicted), cellular towers 106A, and the like). The remote data gateway 106 may be communicatively coupled to a remote server 108. For example, when a cellular tower 106A is use as the remote gateway, it may connect wirelessly or by landline/internet to remote server 108. In another example, when a low-earth orbiting satellite 106B (such as a Starlink satellite of the Starlink satellite internet constellation) is used as a gateway, the satellite/satellite system may employ a bent pipe to downlink the communications to the remote server 108 or to the internet and then to the remote server 108. The remote server 108 may be communicatively coupled to one or more user devices 110 (e.g., desktop computer 110A, smartphone 110B, tablet computer 110C, or the like), such as by the internet or an intranet. It is contemplated herein that the user devices 110 may be configured to include applications (e.g., “apps”) configured to allow a user 112 (e.g., farmhand, rancher, and the like) to view, adjust, or modify one or more characteristics of system 100. For example, in some embodiments, such an application may provide a satellite image of a parcel of land where livestock (103, 105) are to be managed and allow the user 112 to select points which will establish boundary data which, when the points are connected provide a virtual boundary 120 or geo-fence for containment of livestock (103, 105) that are being managed.

In FIG. 1, a virtual boundary 120A was specified by a user 112 via a user device 110 and transmitted to primary collar 104 via server 108 and remote wireless gateway 106. Based on user specified information the virtual boundary was provide to primary collar 104 as a three-level boundary system (with virtual boundaries 120B and 120C being the other two levels). Similarly, a virtual boundary 130 may be specified by user 112 about a water source 131, a virtual boundary 140 may be specified about a mineral source 141, and/or a virtual boundary 150 (in this case a three-level virtual boundary 150A, 150B, and 150C) may be specified about a hazard/obstacle 151 which livestock are meant to avoid. In some embodiments, as depicted, a virtual boundary 150A represents an exclusion/hazard area 151 (which animals are to be kept out of) within a grazing area boundary 120A. These and other virtual boundaries and information (such as the location of a gate) may be similarly transmitted to primary collar 104 and then on to secondary collars 102 (which receive information via an ad hoc/short-range wireless coupling to primary collar 104 or via an ad hoc/short-range wireless coupling to another secondary collar).

As mentioned previously, in various embodiments, the primary collar 104 may be communicatively coupled to one or more secondary collars 102 such as via an ad hoc wireless network and/or a short-range wireless network. The IEEE 802.15.4 specification provides one suitable example of an ad hoc/short-range personal area network which may be ad hoc. It should be appreciated that other suitable standards such as Bluetooth, Zigbee, and the like may be employed. The primary collar 104 may function as a local data gateway (e.g., a local but ambulatory/self-moving base station) by receiving animal location data and/or animal activity data from one or more secondary collars 102 (e.g., 102-1 . . . 102-N), packaging the received data, and sending the packaged data to a server 108 and/or a user device 119 via a remote wireless data gateway 106. The one or more secondary collars 102 may collect animal location information/data via an on-board Global Navigation Satellite System (GNSS) receiver device and transmit the animal data to a primary collar 104. The one or more secondary collars 102 may collect and/or classify animal activity data via an on-board sensor(s) and transmit the animal activity data to a primary collar 104. A secondary collar 102 may package animal location data with its classified animal activity data for the secondary livestock animal 103 about whose neck the secondary collar is worn. That is, the packaged information would indicate an animal activity (e.g., drinking water, standing still, grazing, lying down, walking, eating minerals, and the like) of a secondary livestock animal 103 associated with a particular secondary collar 102 at an animal location of the secondary livestock animal 103. The primary collar 104 may similarly collect animal location data/information via an on-board GNSS receiver device and/or collect/classify animal activity based on information measured by one or more on-board sensors. The primary collar 104 may package animal location data with its classified animal activity data for the primary livestock animal 105 about whose neck the primary collar 104 is worn. That is, the packaged information would indicate an animal activity (e.g., drinking water, standing still, grazing, lying down, walking, eating minerals, and the like) of the primary livestock animal 105 associated with the primary collar 104 at an animal location of the primary livestock animal 105.

With reference to livestock 103/105 depicted in FIG. 1, primary livestock animal 105 is wearing and associated with primary collar 104; secondary livestock animal 103-1 is wearing and associated with secondary collar 102-1; secondary livestock animal 103-2 is wearing and associated with secondary collar 102-2; secondary livestock animal 103-3 is wearing and associated with secondary collar 102-3; and secondary livestock animal 103-N is wearing and associated with secondary collar 102-N. As depicted, primary collar 104 communicates with remote wireless gateway 106 and with secondary collars 102-1, 102-3, and 102-N (which are the secondary collars within its short-range communication range). Secondary collar 102-2 is out-of-range of primary collar 104, and thus utilizes ad hoc mesh network protocols to communicate with primary collar 104 via secondary collar 102-1.

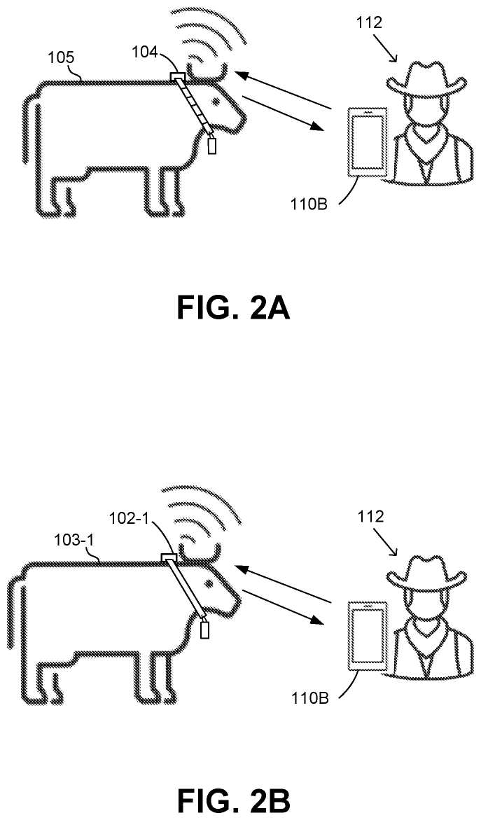

FIG. 2A illustrates example short range wireless communication between a user device 110 (110B in this example) and a primary collar 104, in accordance with one or more embodiments. Such communication may be used when user 112 is near (i.e., within short-range wireless communication range) of primary collar 104 (i.e., is in the field with primary livestock animal 105, rather than remote). In this manner, the primary collar 104 may locally communicate data to the device 110 or receive instructions from the device 110.

FIG. 2B illustrates example short range wireless communication between a user device 110 (110B in this example) and a secondary collar 102 (102-1 in this example), in accordance with one or more embodiments. Such communication may be used when user 112 is near (i.e., within short-range wireless communication range) of a secondary collar 102 (i.e., is in the field with secondary livestock animal 103-1, rather than remote). In this manner, the secondary collar 102 may locally communicate data to the device 110 or receive instructions from the device 110.

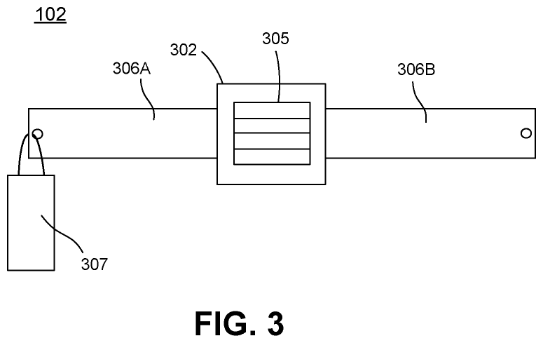

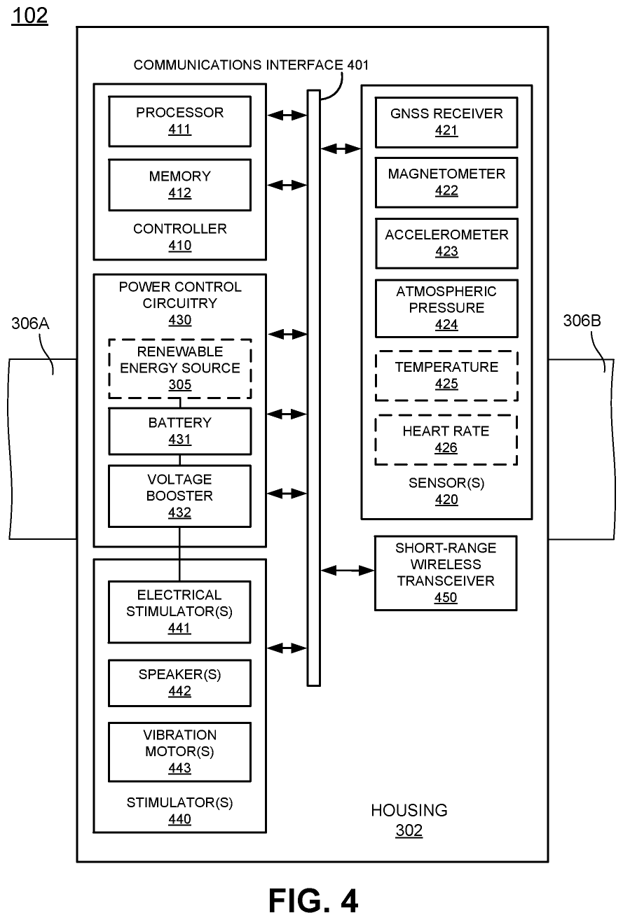

FIG. 3 illustrates an example external diagram of a secondary collar 102, in accordance with one or more embodiments. In embodiments, as illustrated in 1, FIG. 2B, FIG. 3, and FIG. 4, a secondary collar 102 may be comprised of a flexible collar strap 306 which may be in multiple segments (e.g., 306A, 306B, and the like), a suitable latch/fastening mechanism (not depicted), and an optional counterweight 307 which keeps electronics housing 302 centered at the top of the neck of a livestock animal when wearing secondary collar 102. Although only one housing 302 is depicted, electronic components may be spread across multiple such housings (e.g., two, three, or four). In some embodiments the segments 306A and 306B are electrically isolated from one another so that electrical nodes/conductors in only one may be selected to facilitate directional (i.e., one side only) electrical stimulation. In some embodiments, the flexible strap 306 is adjustable to a desired length to customize the fit. In some embodiments, housing 302 may be equipped with solar cells 305 which are utilized to recharge a battery/power source of secondary collar 102. The flexible collar strap 306 may be made of any suitable material and may include electrical nodes or other conductive material on a side meant to face the hide of a livestock animal. The electrical nodes or other conductive material conduct and transmit voltage for electrically stimulating a livestock animal. It should be appreciated that flexible straps 306 have nodes/conductors that are designated as “positive” and “negative” and that an electrical shock is generates as charge flows through the hide of an animal between positive and negative nodes/conductors. In some embodiments, the flexible collar strap 306 may be made of or include ribbon-like polyethylene tape option that is made from woven strands of non-conductive polyethylene which are laced with conductive metal threads that transmit voltage for electrically stimulating a livestock animal (this material is often referred to as “polytape” and is conventionally used as an electrical fencing material).

FIG. 4 illustrates a block diagram depicting an example hardware architecture of the secondary collar 102, in accordance with one or more embodiments. In various embodiments, secondary collar 102 includes one or more controllers 410, one or more sensors 420, power control circuitry 430, one or more stimulators 440, and a short-range wireless transceiver 450 for facilitating ad hoc/short-range wireless communication which may be implemented as a mesh network. A communication interface 401 (which may be one or more suitable communication buses) communicatively couples the components of the hardware architecture.

In embodiments, the short-range wireless transceiver(s) may be configured to transmit animal location data and animal activity data to and receive boundary information from a primary collar 104, as illustrated in FIG. 1. The short-range wireless transceiver may also communicate with other secondary collars 102 in a mesh network or other personal area network.

Controller 410 may include one or more processors 411 and memory 412. In embodiments, the one or more processors 411 are configured to execute a set of program instructions stored in the memory 412, the set of program instructions configured to cause the one or more processors to carry out one or more steps of a method of the present disclosure.

Sensors 420 may include a GNSS receiver 421 for measuring one or more positions of a livestock animal over time as it ambulates/walks about, a magnetometer 422 for measuring heading/directional orientation, one or more accelerometers 423 for measuring velocity and acceleration along with head and body position and movement data, an atmospheric pressure sensor for measuring changes in elevation/altitude of the head and/or body of the livestock animal. In some embodiments, sensors 420 may also include a temperature sensor 425 for measuring one or more of ambient temperature and animal temperature and a heart rate sensor 426 for measuring the heart rate of an animal. In some embodiments accelerometer 423, alone or along with magnetometer 422 and atmospheric pressure sensor 424, may provide position change data in the absence of position change data from GNSS receiver 421 or in order to power down GNSS receiver 421 to conserve power. For example, one or some combination of these sensors may operate as an inertial navigation system to provide position data in the absence of GNSS position data.

Power control circuitry 430 may include a battery 431, a voltage booster 432, and optionally a renewable energy source 305 (such as solar cells) to recharge battery 431.

Stimulators 440 may include one or more (i.e., bi-lateral to a livestock animal) electrical stimulators 441 which are coupled with voltage booster 432 to provide a controlled electrical shock to the livestock animal; one or more (i.e., bi-lateral to a livestock animal) speakers/buzzers 442 to provide audio stimulation to the livestock animal; and/or one or more (i.e., bi-lateral to a livestock animal) vibration motors 443 to provide vibratory stimulation to the livestock animal. When included, bi-lateral stimulation components allow for applying directional stimulation (e.g., unilaterally to only the side of the livestock animal that is nearest a virtual boundary that is not to be crossed).

For example, voltage booster 432 may supply high voltage which is routed by electrical stimulator 441 to nodes and/or conductors embedded in the flexible straps (one or both) of a collar, to provide a shock to the livestock animal wearing the collar

In some embodiments, the secondary collar 102 may be configured to be put in an awake state or a sleep state depending on measurements taken by the on-board accelerometer 423. For example, if the accelerometer 423 reads an acceleration below a selected threshold (e.g., at or near zero), the secondary collar 102 may be put into a sleep state until the accelerometer 423 measures a value above the selected threshold, in which case the secondary collar would be switched into an awake state.

In some embodiments, data measured by one or more sensors may be used to classify the activity of the animal as one or more of: drinking water, standing still, grazing, lying down, walking, and eating minerals. For example, location data from GNSS receiver 421 may be used to determine when the animal has crossed a virtual boundary 130 associated with a water source 131 or crossed a virtual boundary 140 associated with a mineral source 141. In some embodiments, when in a boundary 130 associated with water 131, mouth movements detected by accelerometer 423 and/or head tilt detected by accelerometer 423 and/or atmospheric sensor 424 may be used in conjunction with the location data to classify the animal as “drinking water.” In some embodiments, when in a boundary 140 associated with minerals 141, mouth movements detected by accelerometer 423 and/or head tilt detected by accelerometer 423 and/or atmospheric sensor 424 may be used in conjunction with the location data to classify the animal as “eating minerals.” Similarly, in some embodiments, sensor data may be used to classify animal activity data as “standing still” (e.g., when no movement is detected by GNSS receiver 421 over a specified period of time and no decrease of altitude associated with lying down has been detected by atmospheric pressure sensor 424). In some embodiments, accelerometer data may be monitored to determine a change in acceleration which indicates that a livestock animal is standing up from a lying down position or lying down from a standing up position. In some embodiments, sensor data may be used to classify animal activity data as “grazing” (e.g., when head tilt/mouth movement is detected outside areas associated with water 131 or mineral 141). In some embodiments, sensor data may be used to classify animal activity data as “lying down” (e.g., when there is no walking movement detected by accelerometer 423, no movement detected by GNSS receiver 421, and a decrease in elevation associated with a change from standing to lying down is measured by atmospheric pressure sensor 424). In some embodiments, sensor data may be used to classify an animal activity as “walking” (e.g., when GNSS receiver 431 detects movement over a short period of time and/or accelerometer 423 detects shock/vibration associated with walking). The classified animal activity may be transmitted as “animal activity data” packaged with a GNSS location of the livestock animal where (and when) the classified animal activity took place.

In another embodiment, the functionality of the secondary collar 102 may alternatively be embodiment in the form of a livestock ear tag (not illustrated). The ear tag design 102 may comprise one or more batteries, one or more controllers, one or more solar panels, one or more audio stimulation components (e.g., a speaker, buzzer, and the like), one or more vibration stimulation components (e.g., a vibration motor), one or more electrical stimulation components, one or more short-range transceivers, one or more GNSS units, one or more magnetometers, one or more accelerometers, one or more heart rate monitors, one or more temperature sensors, one or more voltage booster circuits, and/or one or more power management circuitries.

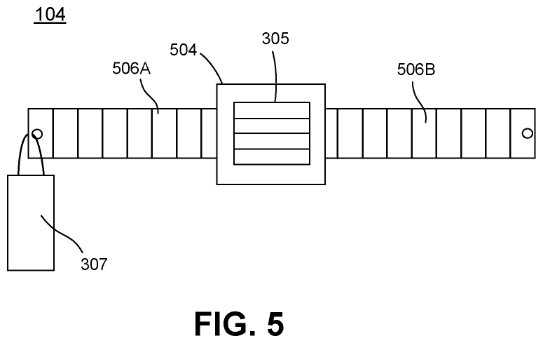

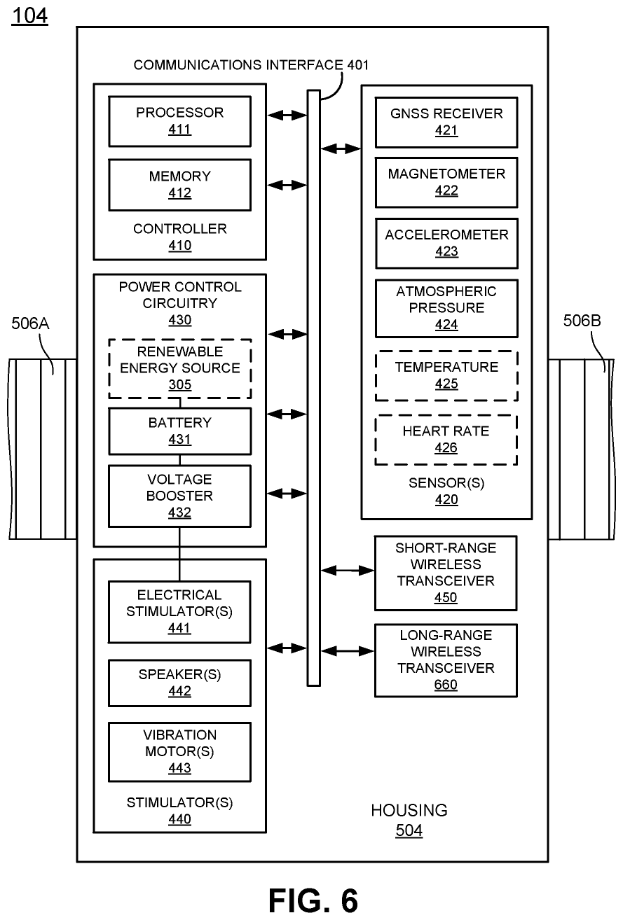

FIG. 5 illustrates an example external diagram of a primary collar, in accordance with one or more embodiments. In embodiments, as illustrated in FIG. 1, FIG. 2A, and FIG. 6, the primary collar 104 may be comprised of a flexible collar strap 506 which may be in multiple segments (e.g., 506A, 506B, and the like), a suitable latching/fastening mechanism (not depicted), and an optional counterweight 307 which keeps electronics housing 504 centered at the top of the neck of a livestock animal when wearing collar 104. Although only one housing 502 is depicted, electronic components may be spread across multiple such housings (e.g., two, three, or four). In some embodiments, the flexible strap 506 is adjustable to a desired length to customize the fit. In some embodiments the segments 506A and 506B are electrically isolated from one another so that electrical nodes/conductors in only one may be selected to facilitate directional (i.e., one side only) electrical stimulation. In some embodiments, housing 504 may be equipped with solar cells 305 which are utilized to recharge a battery/power source of primary collar 104. The flexible collar strap 506 may be made of any suitable material and may include electrical nodes or other conductive material on a side meant to face the hide of a livestock animal. The electrical nodes or other conductive material conduct and transmit voltage for electrically stimulating a livestock animal. It should be appreciated that flexible straps 506 have nodes/conductors that are designated as “positive” and “negative” and that an electrical shock is generates as charge flows through the hide of an animal between positive and negative nodes/conductors. In some embodiments, the flexible collar strap 506 may be made of or include a metal chain that conducts and transmits voltage for electrically stimulating a livestock animal. In some embodiments, the flexible collar strap 506 may be made of or include ribbon-like polyethylene tape option that is made from woven strands of non-conductive polyethylene which are laced with conductive metal threads that transmit voltage for electrically stimulating a livestock animal (this material is often referred to as “polytape” and is conventionally used as an electrical fencing material).

FIG. 6 illustrates a block diagram depicting an example hardware architecture of the primary collar 104, in accordance with one or more embodiments. In some embodiments, the components and functionality are the same as previously described in conjunction with FIG. 4 except that electronics housing 504 includes one or more long-range wireless transceiver 660 for communicating with a remote wireless gateway 106 and the functions are provided with respedct to a primary collar. Long-range transceiver 660 may be a Wi-Fi transceiver, a cellular transceiver, and/or a satellite communications transceiver.

In embodiments, the one or more long-range transceivers may be configured to transmit and receive packaged animal data (location data and activity data for one or several secondary livestock animals 103 and the primary livestock animal 105)) to a remote wireless gateway 106 and to receive boundary data and other information and instructions transmitted through remote wireless gateway 106 data gateway, as are illustrated in FIG. 1.

In embodiments, the short-range transceivers(s) 450 may be configured to transmit boundary data to one or more secondary collars 102 and receive animal location data and/or animal activity data from one or more secondary collars 102, as illustrated in FIG. 1.

In some embodiments, the primary collar 104 may be configured to be put in an awake state or a sleep state depending on measurements taken by the on-board accelerometer 423. For example, if the accelerometer 423 reads an acceleration below a selected threshold (e.g., at or near zero), the primary collar 104 may be put into a sleep state until the accelerometer 423 measures a value above the selected threshold, in which case the primary collar 104 would be switched into an awake state.

### Example Methods of Operation

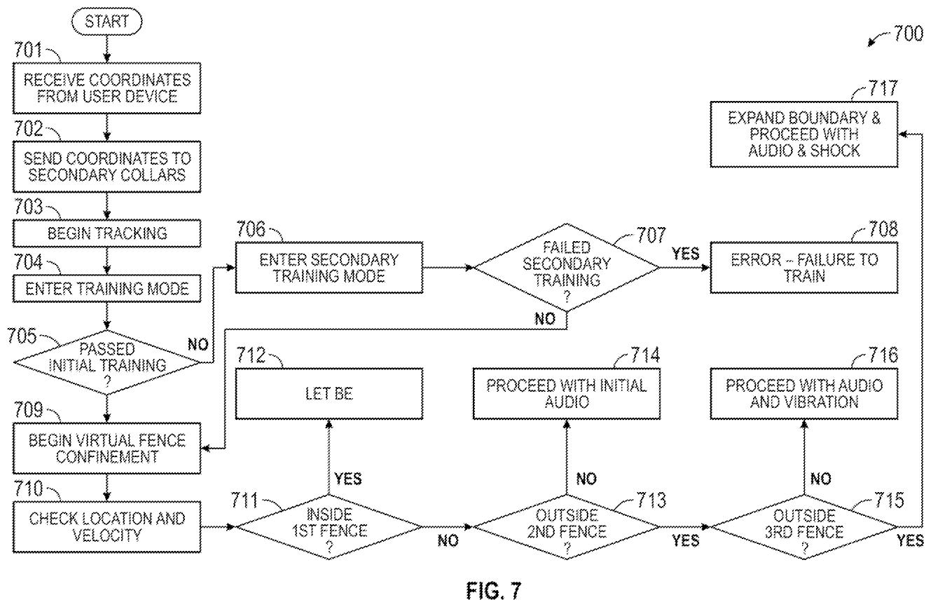

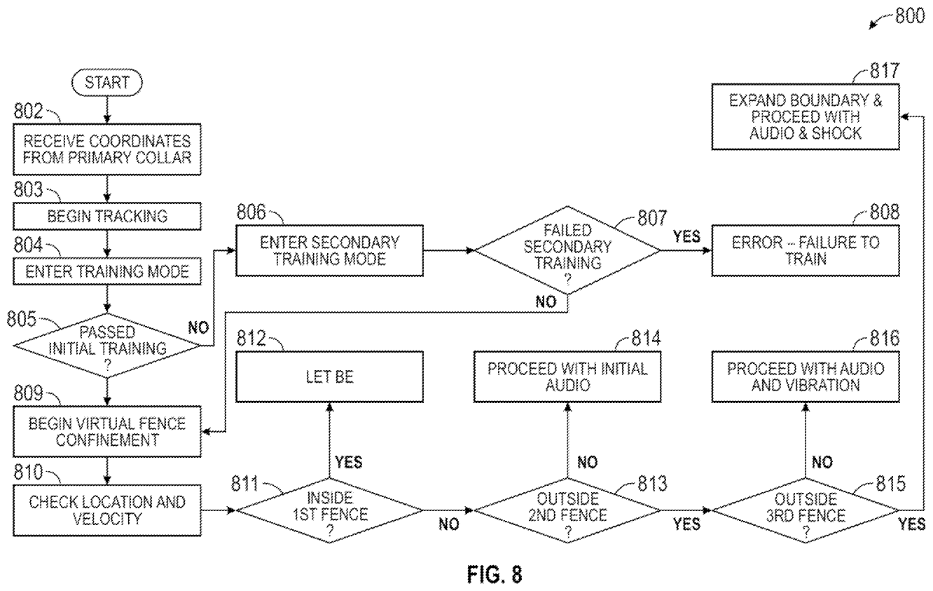

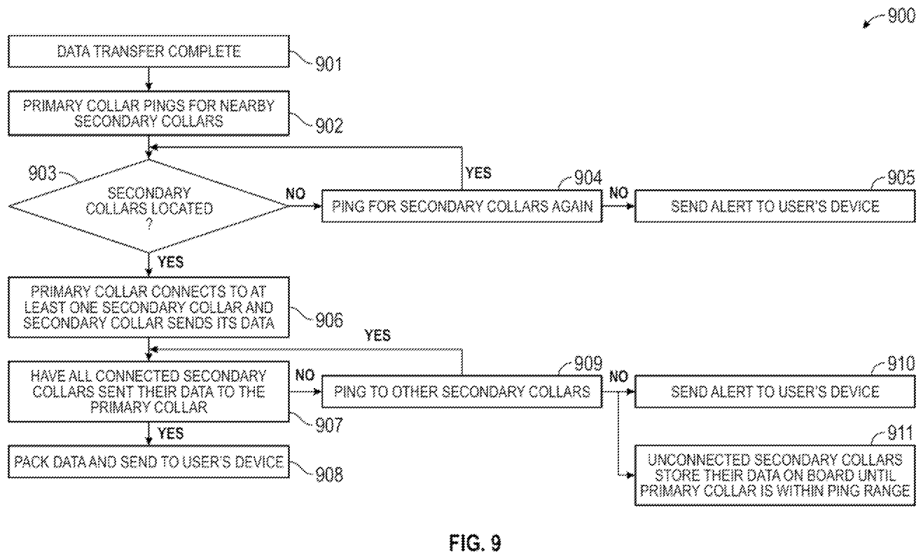

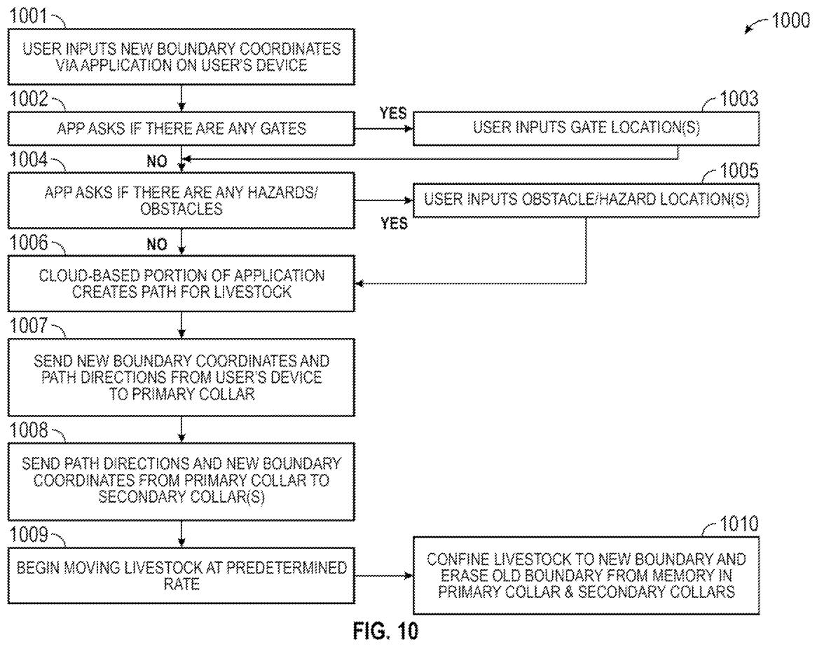

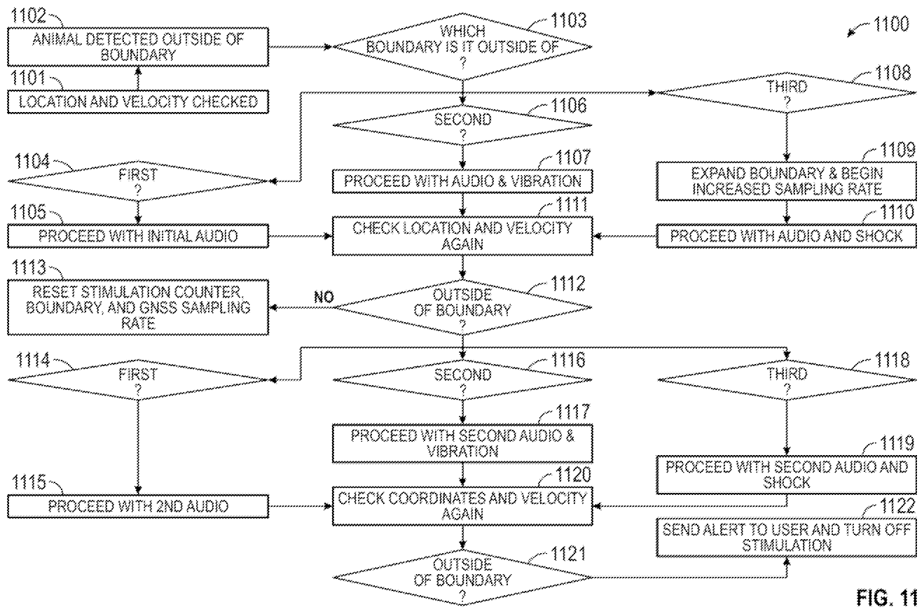

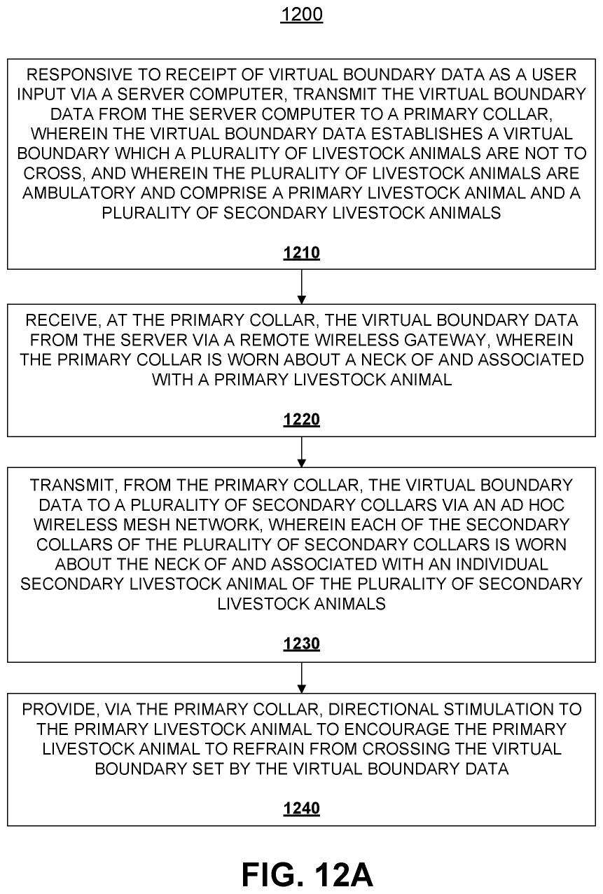

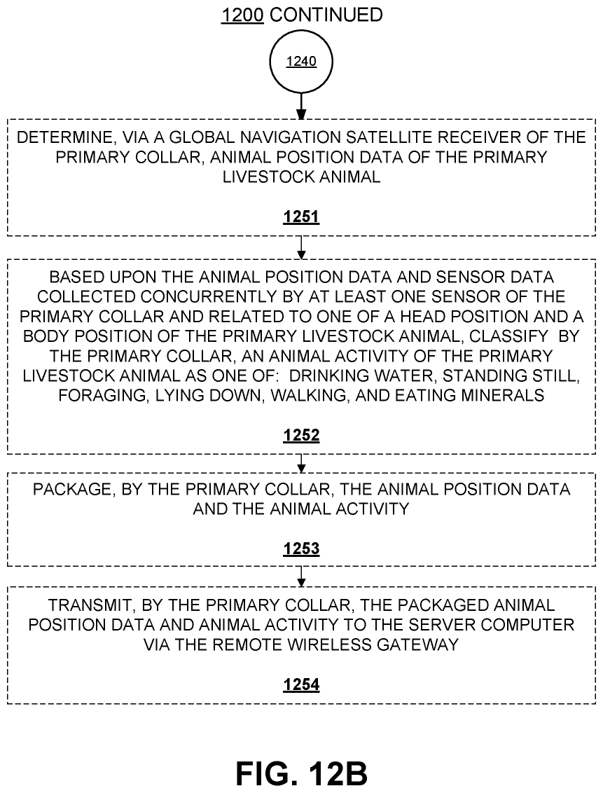

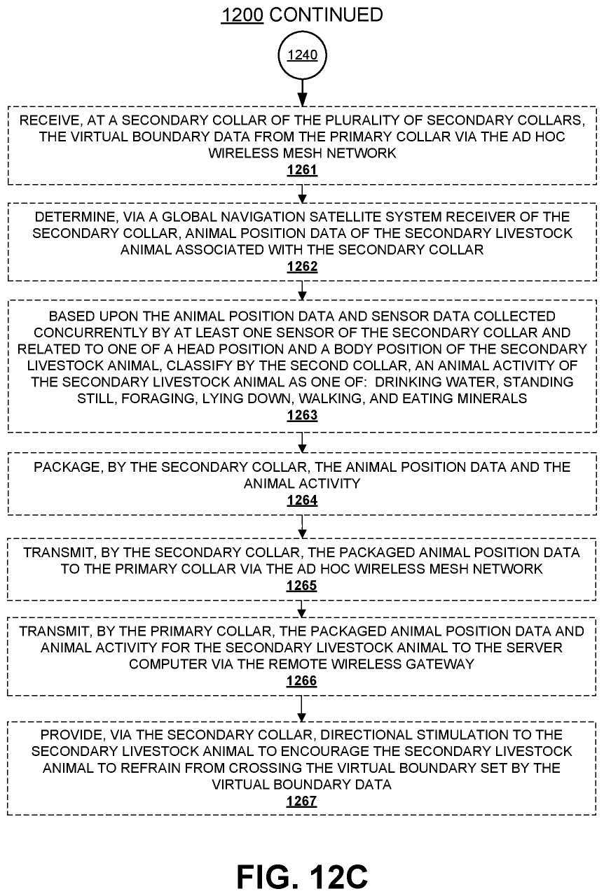

Procedures of the methods illustrated by flow diagram 700 of FIG. 7, flow diagram 800 of FIG. 8, flow diagram 900 of FIG. 9, flow diagram 1000 of FIG. 10, flow diagram 1100 of FIG. 11, and flow diagram 1200 of FIGS. 12A-12C will be described with reference to elements and/or components of one or more of FIGS. 1-6. It is appreciated that in some embodiments, the procedures may be performed in a different order than described in a flow diagram, that some of the described procedures may not be performed, and/or that one or more additional procedures to those described may be performed. Flow diagram 700, 800, 900, 1000, 1100, and 1200 include some procedures that, in various embodiments, are carried out by one or more processors (e.g., processor 411 of a collar 102/104 or any processor or a computer 108 or 110 to which a collar 102 or a collar 104 is communicatively coupled) under the control of computer-readable and computer-executable instructions that are stored on non-transitory computer-readable storage media (e.g., memory 412 of a collar 102/104 or memory of a computer 108/110 to which a collar 102/104 is communicatively coupled). It is further appreciated that one or more procedures described in flow diagrams 700, 800, 900, 1000, 1100, and 1200 may be implemented in hardware, or a combination of hardware with firmware and/or software.

FIG. 7 illustrates a flow diagram 700 depicting an example method for a primary collar 104 to confine a primary livestock animal 105 and/or a group of animals (103/105) by communicating with a user device 110 and secondary collars 102, in accordance with one or more embodiments.

A user selects a confinement region for livestock animals via an application on user device 110, and the application generates boundary data in the form of geographic coordinates which are communicated to primary collar 104.

At 701, boundary information is received at primary collar 104. In embodiments, the boundary information is comprised of geographic coordinates sent from a user device 110. For example, as illustrated in FIG. 1, a user 112 may input coordinates using a user device 110. The user device 110 may send the received coordinates to a remote server 108. The remote server 108 may send the received coordinates to a remote wireless gateway 106, and the remote data gateway 106 may send the received coordinates to a primary collar 104.

At 702, boundary information is transmitted to one or more secondary collars 102. In embodiments, the boundary information is comprised of geographic coordinates. For example, a primary collar 104 may transmit boundary information in the form of geographic coordinates to one or more secondary collars 102 via a short-range wireless transceiver 450.

At 703, the primary collar 104 may begin tracking the location of the primary livestock animal 105 wearing the collar 104. In embodiments, the GNSS receiver 421 on the primary collar 104 may collect measurements regarding the location of the animal wearing the collar. It is noted herein that the primary collar 104 may begin tracking temperature, heart rate, acceleration, and elevation change, heading change, and the like during at this time or later.

At 704, the primary collar 104 may enter training mode. In embodiments, training mode may be used to indicate whether an animal wearing the primary collar 104 is receptive to stimulus provided to keep said animal within a defined boundary. This training may occur in the presence of a user 112, who may be able to verify that an animal passes the training. The training may be automatically monitored such as by applying a stimulation and monitoring the animal's reaction, if any, to the stimulation. If reactions are within a prespecified range an animal is deemed to have passed initial training. As part of initial training, an animal may be introduced to and trained on directional stimulation to see if the animal is responsive to directional stimulation. If initial training is passed at 705, virtual fence confinement begins at 709. If not passed, a secondary training mode 706 may be entered. In the secondary training mode, the initial training may be repeated and/or the level of stimulation may be increased to see if desired reactions can be induced from the stimulation. If the animal fails at 707, an error message for failure to train is generated at 708 and sent back to a user device 110 and the animal and the primary collar 104 are taken out of training mode. If the secondary training is passed, then virtual fence confinement begins at 709.

At 709, in some embodiments, virtual fence confinement may comprise using stimulus devices on the collar 104 to confine the animal 105 wearing the collar to a defined boundary, such as virtual boundary 120A.

In a step 710, the location information and velocity of the animal wearing the collar may be checked by the primary collar. In embodiments, the location information may be compared to a three-level boundary system. It is noted herein that an example of the multi-level boundary system (with three boundary levels/layers) is illustrated in FIG. 1 of the present disclosure.

At 711, when inside the first boundary level 120C, the stimulus components on the collar remain inactive and the animal is left alone and not stimulated at 712. At 711, when outside the first boundary level 120C but inside the second boundary level 120B, the audio stimulus components may be activated at 714, and a comparison made between the location information and the second boundary level 120B. At 713, if outside of the second boundary level 120B but inside the third boundary level 120A, audio and vibration stimulus components may be activated at 716 and a comparison made between the location information and the third boundary level 120A. If outside the third boundary level at 715, the prior stimulus components may remain activated, and the boundary may be expanded to encompass the animal and/or shock stimulation may be added at 717. In some embodiments if the animal remains outside of the third boundary level 120 after a predetermined time of stimulus application at 717, an alert may be sent to a user 112 (e.g., to the user's device 110) and the stimulation components on the collar 104 turned off.

In a similar fashion, a multi-level virtual boundary (e.g., 150A, 150B, and 150C) may be employed to keep an animal from entering an area with an obstacle or a hazard.

FIG. 8 illustrates a flow diagram 800 depicting an example method for a secondary collar 102 to confine a secondary livestock animal 103 by communicating with a primary collar 104, in accordance with one or more embodiments.

A user selects a confinement region for livestock animals via an application on user device 110, and the application generates boundary data in the form of geographic coordinates which are communicated to primary collar 104. The boundary information is received at primary collar 104. In embodiments, the boundary information is comprised of geographic coordinates sent from a user device 110. For example, as illustrated in FIG. 1, a user 112 may input coordinates using a user device 110. The user device 110 may send the received coordinates to a remote server 108. The remote server 108 may send the received coordinates to a remote wireless gateway 106, and the remote data gateway 106 may send the received coordinates to a primary collar 104. The primary collar 104 interprets the boundary information as a virtual boundary, such as virtual boundary 120A of FIG. 1.

At 802, boundary information is received at a secondary collar 102 after being transmitted from a primary collar 104. In embodiments, the boundary information is comprised of geographic coordinates. For example, a primary collar 104 may transmit boundary information in the form of geographic coordinates to one or more secondary collars 102 via a short-range wireless transceiver 450. The secondary collar(s) 102 interpret(s) the boundary information as a virtual boundary, such as virtual boundary 120A of FIG. 1.

At 803, the secondary collar 102 may begin tracking the location of the secondary livestock animal 103 wearing the collar 102. In embodiments, the GNSS receiver 421 on the secondary collar 102 may collect measurements regarding the location of the animal wearing the collar. It is noted herein that the secondary collar 102 may begin tracking temperature, heart rate, acceleration, and elevation change, heading change, and the like during at this time or later.

At 804, the secondary collar 102 may enter training mode. In embodiments, training mode may be used to indicate whether an animal wearing the secondary collar 102 is receptive to stimulus provided to keep said animal within a defined boundary. collar 104 is receptive to stimulus provided to keep said animal within a defined boundary. This training may occur in the presence of a user 112, who may be able to verify that an animal passes the training. The training may be automatically monitored such as by applying a stimulation and monitoring the animal's reaction, if any, to the stimulation. If reactions are within a prespecified range an animal is deemed to have passed initial training. As part of initial training, an animal may be introduced to and trained on directional stimulation to see if the animal is responsive to directional stimulation. If initial training is passed at 805, virtual fence confinement begins at 809. If not passed, a secondary training mode 806 may be entered. In the secondary training mode, the initial training may be repeated and/or the level of stimulation may be increased to see if desired reactions can be induced from the stimulation. If the animal fails at 807, an error message for failure to train is generated at 808 and sent back to a user device 110 and the animal and the secondary collar 102 are taken out of training mode. If the secondary training is passed, then virtual fence confinement begins at 809.

At 809, in some embodiments, virtual fence confinement may comprise using stimulus devices on the collar 102 to confine the animal 103 wearing the collar to a defined boundary, such as virtual boundary 120A.

In a step 810, the location information and velocity of the animal wearing the collar may be checked by the secondary collar 102. In embodiments, the location information may be compared to a three-level boundary system. It is noted herein that an example of the multi-level boundary system (with three boundary levels) is illustrated in FIG. 1 of the present disclosure.

At 811, when inside the first boundary level 120C, the stimulus components on the collar remain inactive and the animal is left alone and not stimulated at 812. At 811, when outside the first boundary level 120C but inside the second boundary level 120B, the audio stimulus components may be activated at 814, and a comparison made between the location information and the second boundary level 120B. At 813, if outside of the second boundary level 120B but inside the third boundary level 120A, audio and vibration stimulus components may be activated at 816 and a comparison made between the location information and the third boundary level 120A. If outside the third boundary level at 815, the prior stimulus components may remain activated, and the boundary may be expanded to encompass the animal and/or shock stimulation may be added at 817. In some embodiments if the animal remains outside of the third boundary level 120 after a predetermined time of stimulus application at 817, an alert may be sent to a user 112 (e.g., to the user's device 110) and the stimulation components on the collar 102 turned off.

In a similar fashion, a multi-level virtual boundary (e.g., 150A, 150B, and 150C) may be employed to keep an animal from entering an area with an obstacle or a hazard.

FIG. 9 illustrates a flow diagram 900 depicting an example method in which a primary collar 104 communicates with one or more secondary collars 102 (102-1, 102-2, 102-3 . . . 102-N), in accordance with one or more embodiments. It is noted herein that the procedures of method 900 may be implemented all or in part by the system 100 illustrated in FIG. 1. It is further recognized, however, that the method illustrate by flow diagram 900 is not limited to the system 100 illustrated in FIG. 1 in that additional or alternative system-level embodiments may carry out all or part of the procedures.

At 901, data transfer between a remote wireless gateway 106 and a primary collar 104 is completed and the primary collar 104 begins collecting new data to send to server 108 and/or user device 110 and begins sending received boundary data out to secondary collars 102.

At 902, primary collar 104 pings via its short-range wireless transceiver 450 for nearby secondary collars 102. In embodiments, as illustrated in FIG. 1, a primary collar 104 may try to locate one or more nearby secondary collars 102 (e.g., secondary collars 102-1, 102-3, and 102-N) which are within its wireless communication range. in order to transmit and receive boundary data and animal location data.

At 904, if no secondary collars respond to the pings at 901, the primary collar 104 again pings for nearby secondary collars 102. If no secondary collars are located after the second pinging (or after a predetermined other number of pinging attempts or amount of time), the primary collar 104 may send an alert at 905 to a user 112 via the user's device 110.

At 903, if one or more secondary collars 102 are located via the pinging, the method proceeds to 906. At 906, the primary collar 104 connects to one or more secondary collars 102 that were located via the pinging and the secondary collars 102 send their animal location data and/or their animal activity data (which may be packaged together for an animal/collar) to the primary collar 104. In embodiments, as illustrated in FIG. 1, one or more secondary collars 102 may send their animal location data and/or animal activity data to the primary collar 104, and the primary collar 104 may further package the received data send the packaged animal location data and/or animal activity data to a remote data gateway 106. This packaged animal location data and/or animal activity data may be used by a user 112 for modifications of boundaries, to manage the livestock, and/or determine information about the activities of the livestock.

At 907 if not all secondary collars 102 have responded, the primary collar 104 may ping secondary collars 102 at 909 that did not send animal location data and/or animal activity data at 906. In embodiments, if the primary collar 104 still does not receive animal location data and/or animal activity data from secondary collars 102 that have been pinged, the primary collar 104 may send an alert at 910 to a user 112 (via the user's device 110). At 911 any unconnected secondary collars 102 may store their animal location data and/or animal activity data on board in memory (e.g., memory 412) until the primary collar 104 is able to ping said secondary collars 102 again or until said secondary collars 102 are able to make a mesh network connection through other secondary collars 102 back to primary collar 104 and transfer their stored data.

At 908, primary collar 104 packs the received animal location data and/or animal activity data and sends the data to a user's device 110 via remote wireless gateway 106. In embodiments, as illustrated in FIG. 1, the primary collar 104 may package data received from one or more secondary collars 102 and transmit the packaged data to one or more remote data gateways 106. The remote data gateways 106 may transmit the packaged data to a remote server 108. The remote server 108 may transmit the packaged data to one or more user devices 110 to be accessed by a user 112. This packaged location data may be used by a user 112 for modifications of boundaries, to manage the livestock, and/or determine information about the activities of the livestock.

FIG. 10 illustrates a flow diagram 1000 depicting an example method of moving a collection of livestock animals, in accordance with one or more embodiments. With reference to the discussion of flow diagram 1000 and elsewhere herein, the terms “boundary” refers to a virtual boundary enforced stimulation by a collar 102, 104 unless specified otherwise; the term “boundary information” refers to information that defines the geographic location of a virtual boundary; the term “path” refers to a virtual path which animals are guided upon via stimulation from a collar 102/104; and the term “path information” refers to information which defines the geographic location of the virtual path.

In a step 1001, a user 112 inputs new boundary information through a user device 110 to establish a new virtual boundary similar to virtual boundary 120A of FIG. 1. For example, as illustrated in FIG. 1, a user 112 may input geographic coordinates into a user device 110 via an application provided by server 108 or else operating independently on device 110.

At 1002, the user device 110 (e.g., the application running thereon) prompts the user 112 to input the location of any gates within the boundary set by the geographic coordinates. At 1003 the user inputs coordinates/location information for any gates into the application running on device 110. If there are no gates or after gate information is entered, the method proceeds to 1004.

At 1004, the user device 110 (e.g., the application running thereon) prompts the user 112 to input the location of hazards/obstacles within the boundary set by the geographic coordinates. The user 112 may similarly be prompted for the location of other sites, such as a watering location or a mineral block location. If there is any information to enter, the method proceeds to 1005 and the user 112 enters the information via device 110. If there is no information about obstacles/hazards or other sites to enter, or after the information has been entered, the method moves on to 1006.

At 1006 a cloud-based portion (e.g., at server 108) of the application running on device 110 calculates a path for the livestock (alternatively a user 112 may designate a path via a device 110). The path may be a moving bounded area (e.g., a slowly moving virtual fence) that nudges the livestock animals via stimulation along the computer calculated path from their current location to new location within the boundary specified by the provided geographic coordinates. In various embodiments, the remote server 108 may consider the location of obstacles/hazards and gates to calculate a path for moving the group of livestock animals. In this manner, the path skirts the obstacles/hazards and goes through a gate that is between the current destination and the desired destination associated with the new boundary coordinates.

At 1007, the boundary information inputted on the user device is transmitted to a primary collar along with the path information generated by the server computer 108. In embodiments, as illustrated in FIG. 1, a user device 110 may send geographic coordinates to a remote server 108. The remote server 108 may send the geographic coordinates and path information to a remote wireless gateway 106, and the remote wireless gateway 106 may send the geographic coordinates and the path information to the long-range wireless transceiver 660 of primary collar 104.

At 1008, the primary collar 104 sends the boundary information and the calculated path information to one or more secondary collars 102 via the short-range wireless transceivers 450 of the collars (102, 104). Secondary collars 102 (e.g., secondary collar 102-2 of FIG. 1) outside communication range of the primary collar 104 may receive the boundary information and path information via ad hoc wireless mesh network communication with another secondary collar (e.g., from secondary collar 102-1 to secondary collar 102-2).

At 1009, the primary collar 104 and secondary collars 102 will begin moving the animals wearing the collars, with a moving virtual bounded area (e.g., a moving virtually fenced region or succession of such regions) that follows the path, at a rate defined by the user 112 or at a predetermined rate. Livestock animals are stimulated to remain within the moving virtual bounded area.

At 1010, in various embodiments, the collars (102, 104) will begin by erasing old boundary information from the memory and confining animals to the new boundary when the animals have arrived via the path within a region bounded by the new boundary information.

FIG. 11 illustrates a flow diagram 1100 depicting an example method in which a three-level/layer incremental boundary confines one or more livestock animals, in accordance with one or more embodiments. Although three levels are described, a multi-level boundary may have two levels, three levels, four levels, etc.). It is appreciated that this method may be invoked by other methods described herein, and that the method may similarly be used to keep an animal out of a hazard/obstacle that is similarly surrounded by a multi-level incremental boundary (e.g., two levels, three levels, four levels). For purposes of example only and not of limitation, discussion will refer actions performed by a primary collar 104 worn by primary livestock animal 105. The techniques are equally applicable to a secondary collar 102 worn by a secondary livestock animal 103.

At 1101, location and velocity of a primary livestock animal 105 wearing a primary collar 104 are checked.

At 1102 it is determined that the livestock animal 105 is outside of a virtual boundary 120 (120A, 120B, 120C). At 1103 it is determined which virtual boundary of the multi-level boundaries (120A, 120B, 120C) the livestock animal 105 is outside.

At 1104 it is determined if the animal 105 is outside of a first boundary 120C, and if so the animal 105 is provided with audio stimulation at 1105 (which may be directionally applied) to nudge the animal back within the boundary 120C.

At 1106 it is determined if the animal 105 is outside of a second boundary 120B, and if so the animal 105 is provided with audio stimulation and vibratory stimulation at 1107 (which may be directionally applied) to nudge the animal back within the boundary 120B.

At 1108 it is determined if the animal 105 is outside of a third boundary 120A, and if so two actions take place: a) at 1109, the boundary 120A is expanded to encompass the animal 105 within it and the GNSS receiver's sampling rate in the collar 104 is increased to better track the animal 105; and b) at 1110, the animal 105 is provided with audio stimulation and electrical stimulation/shock stimulation (which may be directionally applied) to nudge the animal back within the previous boundary 120A or within boundary 120B or 120C.

At 1111, the method again checks the location and velocity of the animal 105.

At 1112, it is determined if the animal 105 is still outside of a boundary that it was previously outside.

At 1113, if no longer outside of the boundary, then the nudging via stimulation was successful and the stimulation is turned off and a stimulation counter is reset, the boundary is reset if it was moved to accommodate the animal 105, and the GNSS sampling rate is reset to a lower rate than when the animal 105 was noted to be outside of a virtual boundary.

At 1114 it is determined if the animal 105 is still outside of a first boundary 120C, and if so the animal 105 is provided with second audio stimulation at 1115 (which may be directionally applied) to nudge the animal back within the boundary 120C.

At 1116 it is determined if the animal 105 is still outside of a second boundary 120B, and if so the animal 105 is provided with second audio stimulation and a second vibratory stimulation at 1117 (which may be directionally applied) to nudge the animal back within the boundary 120B.

At 1118 it is determined if the animal 105 is still outside of a third boundary 120A, and if so the animal 105 is provided with a second audio stimulation and a second electrical stimulation/shock stimulation at 1119 (which may be directionally applied) to nudge the animal back within the boundary 120A. The second audio stimulation and second electrical stimulation may be the same as the first of each or varied, such as by being more intense (e.g., louder or of greater voltage) or longer.

At 1120, coordinates and velocity of animal 105 are checked again and it is determined at 1121 if the animal 105 is still outside of a boundary that it was previously outside (or if it is headed back within or headed farther away). If no longer outside of the boundary, then the nudging via stimulation was successful and the stimulation is turned off and a stimulation counter is reset, the boundary is reset if it was moved to accommodate the animal 105, and the GNSS sampling rate is reset to a lower rate than when the animal 105 was noted to be outside of a virtual boundary.

At 1122, if the animal 105 is still outside of a boundary that it was previously outside, stimulation is turned off and an alert is sent to the device 110 of user 112.

FIGS. 12A-12C illustrate a flow diagram 1200 of an example method of virtual livestock management, in accordance with one or more embodiments.

With reference to FIG. 12A, at procedure 1210 of flow diagram 1200, in various embodiments, in response to receipt of virtual boundary data as a user input (e.g., sent from a user device 110) via a server computer 108, the virtual boundary data is transmitted from the server computer 108 to a primary collar 104. The virtual boundary data establishes a virtual boundary 120A which a plurality of livestock animals (103, 105) are not to cross. The plurality of livestock animals are ambulatory, meaning they are mobile and can walk, and comprise a primary livestock animal 105 and a plurality of secondary livestock animals 103.

At 1220, in various embodiments, the primary collar 104 receives the virtual boundary data associated with virtual boundary 120A from the server computer 108 via a remote wireless gateway 106, wherein the primary collar 104 is worn about a neck of and associated with a primary livestock animal 105.

At 1230 the virtual boundary data associated with virtual boundary 120A is transmitted from the primary collar 104 to a plurality of secondary collars 102 via an ad hoc wireless mesh network. Each of the secondary collars (e.g., 102-1) of the plurality of secondary collars 102 is worn about the neck of and associated with an individual secondary livestock animal (e.g., 103-1) of the plurality of secondary livestock animals 103.

At 1240, the primary collar 104 provides directional stimulation to the primary livestock animal 105 to encourage the primary livestock animal 105 to refrain from crossing the virtual boundary 120A set by the virtual boundary data or to move back within the virtual boundary 120A if it has moved outside of the virtual boundary. In some embodiments when a multi-level incremental boundary is used, a technique as described in FIG. 11 may be utilized to provide varied stimulation which may be directional (e.g., on one side of an animal to nudge the animal in a direction away from the stimulation—for example a stimulation on an animal's right side would nudge it to the left).

With reference to FIG. 12B, in some embodiments, the method of flow diagram 1240 further comprises at 1251 determining, via a global navigation satellite system receiver 421 and/or other sensors of the primary collar 104, animal position data of the primary livestock animal 105.

With continued reference to FIG. 12B, in some embodiments, at 1252 based upon the animal position data and sensor data collected concurrently by at least one sensor (e.g., of sensors 420) of the primary collar 104 and related to one of a head position and a body position of the primary livestock animal 105, the primary collar 104 classifies an animal activity of the primary livestock animal 105 as one of: drinking water, standing still, foraging, lying down, walking, and eating minerals. Techniques for such classifying have been previously described herein.

With continued reference to FIG. 12B, in some embodiments, at 1253 the primary collar 104 packages the animal position data and the animal activity. By packaging, it is meant that the two data types are packaged to be sent together to convey a location of a classified activity of the primary livestock animal 105.

With continued reference to FIG. 12B, in some embodiments, at 1254 the primary collar 104 transmits the packaged animal position data and animal activity to the server computer 108 via the remote wireless gateway 106. The server computer may utilize the packaged data and/or forward some or all onward to a device 110 associated with a user 112.

With reference to FIG. 12C, in some embodiments, the method of flow diagram 1240 further comprises at 1261 receiving, at a secondary collar 102 (e.g., at secondary collar 102-1 of FIG. 1) of the plurality of secondary collars 102, the virtual boundary data associated with virtual boundary 120A from the primary collar 104 via the ad hoc wireless mesh network enabled by short-range wireless transceivers 450.

With continued reference to FIG. 12C, in some embodiments, at 1262 the animal position data of the secondary livestock animal 103 (e.g., 103-1) associated with the secondary collar 102 (e.g., 102-1) is determined via position(s) measured by a global navigation satellite system receiver 421 and/or other sensors of the secondary collar 102.

With continued reference to FIG. 12C, in some embodiments, at 1263 based upon the animal position data and sensor data collected concurrently by at least one sensor (e.g., of sensors 420) of the secondary collar 102-1 and related to one of a head position and a body position of the secondary livestock animal 103-1, the secondary collar 102-1 classifies an animal activity of the secondary livestock animal 103-1 as one of: drinking water, standing still, foraging, lying down, walking, and eating minerals. Techniques for such classifying have been previously described herein.

With continued reference to FIG. 12C, in some embodiments, at 1264 the secondary collar 102-1 packages, the animal position data and the animal activity. By packaging, it is meant that the two data types are packaged to be sent together to convey a location of a classified activity of the secondary livestock animal 103-1.

With continued reference to FIG. 12C, in some embodiments, at 1265 the secondary collar 102-1 transmits the packaged animal position data and animal activity to the primary collar 104 via the ad hoc wireless mesh network.

With continued reference to FIG. 12C, in some embodiments, at 1266 the primary collar 104 transmits the packaged animal position data and animal activity for the secondary livestock animal 103-1 to the server computer 108 via the remote wireless gateway 106. The server computer 108 may utilize the packaged data and/or forward some or all onward to a device 110 associated with a user 112.

In the same manner described in 1262 to 1266 a second secondary collar (e.g., secondary collar 102-2) may similarly collect and package animal position data and classified animal activity data and provide them via an ad hoc wireless mesh network/personal area network communication to secondary collar 102-1 which then forwards them to primary collar 104 to be sent to server computer 108.

With continued reference to FIG. 12C, in some embodiments, at 1267 the secondary collar 102 provides directional stimulation to the secondary livestock animal 103 to encourage the secondary livestock animal 103 to refrain from crossing the virtual boundary 120A set by the virtual boundary data or to move back within the virtual boundary 120A if it has moved outside of the virtual boundary. In some embodiments when a multi-level incremental boundary is used, a technique as described in FIG. 11 may be utilized to provide varied stimulation which may be directional (e.g., on one side of an animal to nudge the animal in a direction away from the stimulation).

### Additional Embodiments

In some embodiments, a single livestock animal may be selectively culled from a plurality of livestock animals based on predetermined rules or user input received via device 110. In such embodiments, to improve the behavior of the culled animal, system 100 may automatically select a second livestock animal (or in some embodiments multiple additional livestock animals, but less than entire herd) to pair with the culled animal to provide companionship and prevent separation anxiety. For example, with reference to FIG. 1, if livestock animal 103-2 is selected for culling, instructions may be sent to the collar 102-1 of livestock animal 103-1 to pair it with livestock animal 103-2. A new virtual boundary and a path to that virtual boundary is send to both the collars (102-1 and 102-2) of the paired livestock animals and they are automatically culled from the remaining livestock animals and sent via the path to the location bounded by the new virtual boundary. Selection of one or additional livestock animals for pairing with the animal to be culled may be based on which other animal(s) are nearest to the animal being culled, based on a pre-known affinity between the animals (e.g., a mother may be paired with a child and vice-a-versa), based on similar sex of the animals, based on similar age of the animals, based on similar size of the animals, based on user input, and/or based on other reasons. In some embodiments, an animal may be automatically selected for culling because of a problem with its collar (102, 104) such as a low battery.

In some embodiments, where selective breeding is performed, metrics on animal activity are maintained by server 108 based on reported animal activity for animals 103, 105. One or more reports may be sent from server computer 108 to a device 110 of a user 112, where the reports rank livestock animals based on animal activity. For example, animals may be ranked: from most to least walking; from most to least lying down; from most to least foraging, from most to least standing still, and from most to least drinking of water; from most to least consumption of mineral. Automated or user specified rules may be applied based on the animal activity ranking to select animals to maintain in a breeding herd and animals to remove from a breeding herd.

In some situations, animals may be required to receive supplement injections if they do not consume enough minerals in their diet. Conventionally, if a mineral deficiency is discovered in a herd, all animals in the herd receive an injection even if all do not need the supplementation provide by the injection. In some embodiments, server computer 108 may generate a report ranking managed livestock animals according to their amount of detected mineral consumption. An automated or user specified criteria may be applied to the ranking to determine which livestock animals do not need supplement injection because of adequate mineral consumption. Animals which do need the injection may be culled and moved to a region where a veterinarian or worker will arrive to provide the required injection. Similarly, a list of animals needing veterinary/medical treatment may be provided via user input to a device 110 and those animals may automatically be culled and sent down a virtual path to a specified virtual holding area.

### CONCLUSION

The examples set forth herein were presented in order to best explain, to describe particular applications, and to thereby enable those skilled in the art to make and use embodiments of the described examples. However, those skilled in the art will recognize that the foregoing description and examples have been presented for the purposes of illustration and example only. The description as set forth is not intended to be exhaustive or to limit the embodiments to the precise form disclosed. Rather, the specific features and acts described above are disclosed as example forms of implementing the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

What is claimed:

1. A system for virtual management of livestock, the system comprising:
a server computer configured to receive virtual boundary data as a user input, wherein the virtual boundary data establishes a virtual boundary which a plurality of livestock animals are not to cross, and wherein the plurality of livestock animals are ambulatory and comprise a primary livestock animal and a plurality of secondary livestock animals;
a primary collar configured to be worn by and associated with the primary livestock animal and to communicatively couple with the server computer via a remote wireless gateway;
a plurality of secondary collars configured to communicatively couple wirelessly with one another and with the primary collar via an ad hoc wireless mesh network, wherein each of the secondary collars of the plurality of secondary collars is configured to be worn by and associated with an individual secondary livestock animal of the plurality of secondary livestock animals;
wherein the primary collar is further configured to:
receive the virtual boundary data from the server computer via the remote wireless gateway;
transmit the virtual boundary data to the plurality of secondary collars via the ad hoc wireless mesh network; and
provide directional stimulation to the primary livestock animal associated with the primary collar to encourage the primary livestock animal to refrain from crossing the virtual boundary set by the virtual boundary data.

2. The system of claim 1, wherein the primary collar is further configured to:
receive animal position data and animal activity data from a secondary collar, of the plurality of secondary collars, for a secondary livestock animal of the plurality of secondary livestock animals that is associated with the secondary collar, wherein the animal position data comprises a listing of global navigation satellite system position data collected by the secondary collar over a period of time, and wherein the animal activity data is classified based on the animal position data and one of a head position and a body position of the secondary livestock animal as determined by one or more sensors associated with the secondary collar;
package the received animal position data and animal activity data; and
transmit the packaged animal position data and animal activity data to the server computer via the remote wireless gateway.

3. The system of claim 2, wherein the animal position data further comprises position change data derived from an accelerometer disposed in the secondary collar.

4. The system of claim 2, wherein the animal activity data is a classification of animal activity selected from the list of animal activity consisting of: drinking water, standing still, grazing, lying down, walking, and eating minerals.

5. The system of claim 2, wherein the primary collar comprises:
a global navigation satellite system receiver configured to record geographic positions of the primary collar over time;
an accelerometer for collecting head and body positions of the primary livestock animal;
directional stimulators configured to apply the directional stimulation as of one of a sound and an electrical shock;
a wireless transceiver configured to communicate with the remote wireless gateway; and
a wireless mesh network transceiver configured to wirelessly communicate with secondary collars of the plurality of secondary collars.

6. The system of claim 5, wherein the primary collar further comprises a short-range wireless personal area network transceiver for communicating locally with a local computing device to provide data or receive instructions.

7. The system of claim 2, wherein the secondary collar of the plurality of secondary collars is configured to:
receive the virtual boundary data from the primary collar via the ad hoc wireless mesh network;
transmit first packaged animal position data and activity data, via the ad hoc wireless mesh network, to the primary collar for the secondary livestock animal associated with and wearing the secondary collar; and
provide directional stimulation to the secondary livestock animal associated with and wearing the secondary collar to encourage the secondary livestock animal to remain within the virtual boundary set by the virtual boundary data.

8. The system of claim 7, wherein the secondary collar of the plurality of secondary collars is further configured to:
transmit packaged second animal position data and second animal activity data from a second secondary livestock animal of the plurality of secondary livestock animals that is associated with a second secondary collar of the plurality of secondary collars, wherein the secondary collar has received the second secondary livestock animal and position data via ad hoc wireless mesh network communication with the second secondary collar.

9. The system of claim 8, wherein the secondary collar comprises:
a global navigation satellite system receiver configured to measure global navigation satellite system position data of the secondary collar over time;
an accelerometer for collecting the animal activity data associated with the secondary livestock animal;
directional stimulators configured to apply the directional stimulation as of at least one of a sound and an electrical shock; and
a wireless mesh network transceiver configured to wirelessly communicate with the primary collar and other secondary collars of the plurality of secondary collars.

10. The system of claim 9, wherein the secondary collar further comprises a short-range wireless personal area network transceiver for communicating locally with a local computing device to provide data or receive instructions.

11. The system of claim 1, wherein the virtual boundary set by the virtual boundary data comprises an outer boundary of a grazing area for the plurality of livestock animals.

12. The system of claim 1, wherein the virtual boundary set by the virtual boundary data comprises an exclusion area within a grazing area of the plurality of livestock animals.

13. The system of claim 1, wherein the virtual boundary data sets a second virtual boundary around one of a livestock water source and a livestock mineral source.

14. The system of claim 1, wherein the remote wireless gateway comprises at least one of a cellular data gateway and a low earth orbit satellite telecommunications network bent-pipe data gateway.

15. A method of livestock management, the method comprising:
responsive to receipt of virtual boundary data as a user input via a server computer, transmitting the virtual boundary data from the server computer to a primary collar, wherein the virtual boundary data establishes a virtual boundary which a plurality of livestock animals are not to cross, and wherein the plurality of livestock animals are ambulatory and comprise a primary livestock animal and a plurality of secondary livestock animals;
receiving, at the primary collar, the virtual boundary data from the server computer via a remote wireless gateway, wherein the primary collar is worn about a neck of and associated with a primary livestock animal;
transmitting, from the primary collar, the virtual boundary data to a plurality of secondary collars via an ad hoc wireless mesh network, wherein each of the secondary collars of the plurality of secondary collars is worn about the neck of and associated with an individual secondary livestock animal of the plurality of secondary livestock animals; and
providing, via the primary collar, directional stimulation to the primary livestock animal to encourage the primary livestock animal to refrain from crossing the virtual boundary set by the virtual boundary data.

16. The method as recited in claim 15, further comprising:
determining, via a global navigation satellite system receiver of the primary collar, animal position data of the primary livestock animal;
based upon the animal position data and sensor data collected concurrently by at least one sensor of the primary collar and related to one of a head position and a body position of the primary livestock animal, classifying by the primary collar, an animal activity of the primary livestock animal as one of: drinking water, standing still, foraging, lying down, walking, and eating minerals;
packaging, by the primary collar, the animal position data and the animal activity; and
transmitting, by the primary collar, the packaged animal position data and animal activity to the server computer via the remote wireless gateway.

17. The method as recited in claim 15, further comprising:
receiving, at a secondary collar of the plurality of secondary collars, the virtual boundary data from the primary collar via the ad hoc wireless mesh network;
determining, via a global navigation satellite system receiver of the secondary collar, animal position data of the secondary livestock animal associated with the secondary collar;
based upon the animal position data and sensor data collected concurrently by at least one sensor of the secondary collar and related to one of a head position and a body position of the secondary livestock animal, classifying by the second collar, an animal activity of the secondary livestock animal as one of: drinking water, standing still, foraging, lying down, walking, and eating minerals;
packaging, by the secondary collar, the animal position data and the animal activity;
transmitting, by the secondary collar, the packaged animal position data and animal activity to the primary collar via the ad hoc wireless mesh network;
transmitting, by the primary collar, the packaged animal position data and animal activity for the secondary livestock animal to the server computer via the remote wireless gateway; and
providing, via the secondary collar, directional stimulation to the secondary livestock animal to encourage the secondary livestock animal to refrain from crossing the virtual boundary set by the virtual boundary data.

18. A non-transitory computer readable storage medium comprising instructions embodied thereon which, when executed, cause at least one processor to perform a method of livestock management, the method comprising:
responsive to receipt of virtual boundary data as a user input via a server computer, transmitting the virtual boundary data from the server computer to a primary collar, wherein the virtual boundary data establishes a virtual boundary which a plurality of livestock animals are not to cross, and wherein the plurality of livestock animals are ambulatory and comprise a primary livestock animal and a plurality of secondary livestock animals;
receiving, at the primary collar, the virtual boundary data from the server computer via a remote wireless gateway, wherein the primary collar is worn about a neck of and associated with a primary livestock animal;
transmitting, from the primary collar, the virtual boundary data to a plurality of secondary collars via an ad hoc wireless mesh network, wherein each of the secondary collars of the plurality of secondary collars is worn about the neck of and associated with an individual secondary livestock animal of the plurality of secondary livestock animals; and
providing, via the primary collar, directional stimulation to the primary livestock animal to encourage the primary livestock animal to refrain from crossing the virtual boundary set by the virtual boundary data.

19. The non-transitory computer readable storage medium as recited in claim 18, further comprising instructions for:
determining, via a global navigation satellite system receiver of the primary collar, animal position data of the primary livestock animal;
based upon the animal position data and sensor data collected concurrently by at least one sensor of the primary collar and related to one of a head position and a body position of the primary livestock animal, classifying by the primary collar, an animal activity of the primary livestock animal as one of: drinking water, standing still, foraging, lying down, walking, and eating minerals;
packaging, by the primary collar, the animal position data and the animal activity; and
transmitting, by the primary collar, the packaged animal position data and animal activity to the server computer via the remote wireless gateway.

20. The non-transitory computer readable storage medium as recited in claim 18, further comprising instructions for:
receiving, at a secondary collar of the plurality of secondary collars, the virtual boundary data from the primary collar via the ad hoc wireless mesh network;
determining, via a global navigation satellite system receiver of the secondary collar, animal position data of the secondary livestock animal associated with the secondary collar;
based upon the animal position data and sensor data collected concurrently by at least one sensor of the secondary collar and related to one of a head position and a body position of the secondary livestock animal, classifying by the second collar, an animal activity of the secondary livestock animal as one of: drinking water, standing still, foraging, lying down, walking, and eating minerals;
packaging, by the secondary collar, the animal position data and the animal activity;
transmitting, by the secondary collar, the packaged animal position data and animal activity to the primary collar via the ad hoc wireless mesh network;
transmitting, by the primary collar, the packaged animal position data and animal activity for the secondary livestock animal to the server computer via the remote wireless gateway; and
providing, via the secondary collar, directional stimulation to the secondary livestock animal to encourage the secondary livestock animal to refrain from crossing the virtual boundary set by the virtual boundary data.
